(19) United States
(12) Patent Application Publication
(10) Pub. No.: US 2024/0211495 A1
(43) Pub. Date: Jun. 27, 2024

(54) SYSTEMS AND METHODS FOR LABELLING DATA

(71) Applicants: Marc-antoine PELLETIER, Georgeville (CA); Simon CORCOS, Verdun (CA); TECHNOLOGIES HOP-CHILD, INC., Sherbrooke (CA)

(72) Inventors: Marc-Antoine PELLETIER, Georgeville (CA); Simon CORCOS, Verdun (CA); Rozarina MD Yusof HOWTON, Calgary (CA)

(21) Appl. No.: 18/557,703

(22) PCT Filed: Apr. 27, 2022
(86) PCT No.: PCT/CA2022/050637

§ 371 Date: Oct. 27, 2023

Related U.S. Application Data
(60) Provisional application No. 63/180,594, filed on Apr. 27, 2021.

(51) Int. Cl. G06F 16/28; G06F 16/22

(52) U.S. Cl. CPC G06F 16/285; G06F 16/2228

(57) ABSTRACT

Systems, methods, and computer program products for generating a dataset of labelled physiological data points. Data corresponding to an individual is recorded. Input may be received indicating a label. A data point may be generated. The data point may include a timestamp when the input was received or the event is triggered, the label, and a portion of the data corresponding to the time when the input was received. The data point may be stored in a dataset of labelled data points. Labels might be predicted by the system using machine learning algorithm.

### CROSS-REFERENCE TO RELATED APPLICATIONS

This application claims the benefit of U.S. Provisional Patent Application No. 63/180,594, filed on Apr. 27, 2021, which is incorporated by reference herein in its entirety.

### BACKGROUND

Data relating to an individual may be collected, such as physiological data and/or any other type of data. The data may be collected using wearable devices, measured by a clinician, and/or through other methods. It may be advantageous to label the collected data, such as with a label indicating a symptom that the individual is experiencing at a specific time or over a period of time, an activity that the individual is engaged in, a diagnosis, and/or a human phenotype. It may be advantageous to provide a system for labelling data.

### SUMMARY

According to a first broad aspect of the present technology, there is provided a method for generating a dataset of labelled data points, the method comprising: recording, by a device, data corresponding to an individual; receiving, by the device at a first time, first input corresponding to a first label; storing a first data point, wherein the first data point comprises: a first timestamp corresponding to the first time, the first label, and a first portion of the data corresponding to the first time; receiving, by the device at a second time, second input; storing a second data point, wherein the second data point comprises: a second timestamp corresponding to the second time, and a second portion of the data corresponding to the second time; receiving user input indicating a second label for the second time; assigning the second label to the second data point; determining, based on the data, that an event has occurred at a third time; outputting a first user interface indicating that an event has occurred; receiving, via the first user interface, a third label corresponding to the event; storing a third data point, wherein the third data point comprises: a third timestamp corresponding to the third time, the third label, and a third portion of the data corresponding to the event; and storing the dataset of labelled data points comprising the first data point, the second data point, and the third data point.

In some implementations of the method, the method further comprises training a machine learning algorithm based on the dataset.

In some implementations of the method, the method further comprises: outputting a second user interface requesting that the individual consent to the data being collected; and receiving, via the second user interface, an indication that the individual has consented to the data being collected.

In some implementations of the method, recording the data corresponding to the individual comprises recording at least a portion of the data by a micro electro-mechanical system (MEMS) in the device.

In some implementations of the method, the MEMS comprises one or more microphones.

In some implementations of the method, the MEMS comprises one or more accelerometers.

In some implementations of the method, determining that the event has occurred comprises determining, by the device, that the event has occurred.

In some implementations of the method, the method further comprises: encrypting, by the device, the dataset of labelled data points; and transmitting the encrypted dataset of labelled data points.

In some implementations of the method, the method further comprises recording, by a second device, second data corresponding to the individual, wherein the first data point comprises a first portion of the second data corresponding to the first time, wherein the second data point comprises a second portion of the second data corresponding to the second time, and wherein the third data point comprises a third portion of the second data corresponding to the third time.

In some implementations of the method, the device is a wearable device.

According to another broad aspect of the present technology, there is provided a method for generating a dataset of labelled data points, the method being executable by a processor of a computer system, the method comprising: receiving, at a first time, first input corresponding to a first label; storing a first data point, wherein the first data point comprises a first timestamp indicating the first time and the first label; receiving, at a second time, second input indicating that an event is occurring; storing a second data point comprising a second timestamp indicating the second time; receiving, after receiving the second input, third input indicating a second label corresponding to the event; assigning the second label to the second data point; receiving responses to a questionnaire completed by an individual; generating, based on the responses, a third data point comprising a third label; and storing a dataset comprising the first data point, the second data point, and the third data point.

In some implementations of the method, the method further comprises performing semi-supervised learning on the dataset to generate a machine learning algorithm (MLA) for labelling data points.

In some implementations of the method, the method further comprises: receiving physiological data corresponding to the individual; determining, based on the physiological data, a third timestamp corresponding to an event; generating, by the MLA, one or more predicted labels for the third timestamp; generating a fourth data point comprising the third timestamp and the one or more predicted labels; and storing the fourth data point in the dataset.

In some implementations of the method, the method further comprises outputting a user interface for labelling data, and wherein the first input, second input, and third input are received via the user interface.

In some implementations of the method, receiving the first input comprises receiving, via a wearable device, the first input.

In some implementations of the method, receiving the second input comprises receiving, via a wearable device, the second input.

In some implementations of the method, receiving the third input comprises receiving, via a user interface for data labelling, the third input.

In some implementations of the method, the user interface for data labelling is displayed by a personal computer, tablet, or smartphone.

In some implementations of the method, receiving the first input, second input, or third input comprises receiving hand gesture input or sign language input.

According to another broad aspect of the present technology, there is provided a method for generating a dataset of labelled data points, the method comprising: recording, by a device, data corresponding to an individual; receiving, by the device at a first time, first input corresponding to a first label; storing a first data point, wherein the first data point comprises: a first timestamp corresponding to the first time, the first label, and a first portion of the data corresponding to the first time; determining, based on the data, that an event has occurred at a second time; outputting a first user interface indicating that an event has occurred; receiving, via the first user interface, a second label corresponding to the event; storing a second data point, wherein the second data point comprises: a second timestamp corresponding to the second time, the second label, and a second portion of the data corresponding to the event; and storing the dataset of labelled data points comprising the first data point and the second data point.

In some implementations of the method, the method further comprises training a machine learning algorithm based on the dataset.

In some implementations of the method, the method further comprises: outputting a second user interface requesting that the individual consent to the data being collected; and receiving, via the second user interface, an indication that the individual has consented to the data being collected.

In some implementations of the method, recording the data corresponding to the individual comprises recording at least a portion of the data by a micro electro-mechanical system (MEMS) in the device.

In some implementations of the method, the MEMS comprises one or more microphones.

In some implementations of the method, the MEMS comprises one or more accelerometers.

In some implementations of the method, determining that the event has occurred comprises determining, by the device, that the event has occurred.

In some implementations of the method, the method further comprises: encrypting, by the device, the dataset of labelled data points; and transmitting the dataset of labelled data points.

In some implementations of the method, the method further comprises recording, by a second device, second data corresponding to the individual, wherein the first data point comprises a first portion of the second data corresponding to the first time, and wherein the second data point comprises a second portion of the second data corresponding to the second time.

In some implementations of the method, the device is a wearable device.

According to another broad aspect of the present technology, there is provided a wearable device comprising at least one processor, and memory storing a plurality of executable instructions which, when executed by the at least one processor, cause the wearable device to: recording data corresponding to an individual; receive, at a first time, first input corresponding to a first label; store a first data point, wherein the first data point comprises: a first timestamp corresponding to the first time, the first label, and a first portion of the data corresponding to the first time; receive, at a second time, second input; store a second data point, wherein the second data point comprises: a second timestamp corresponding to the second time, and a second portion of the data corresponding to the second time; receive user input indicating a second label for the second time; assign the second label to the second data point; determine, based on the data, that an event has occurred at a third time; receive a third label corresponding to the event; store a third data point, wherein the third data point comprises: a third timestamp corresponding to the third time, the third label, and a third portion of the data corresponding to the event; and store a dataset of labelled data points comprising the first data point, the second data point, and the third data point.

In some implementations of the wearable device, the instructions, when executed by the at least one processor, cause the wearable device to encrypt the dataset of labelled data points.

In some implementations of the wearable device, the instructions, when executed by the at least one processor, cause the wearable device to transmit the dataset of labelled data points to a server.

In some implementations of the wearable device, the wearable device further comprises a micro electro-mechanical system (MEMS).

In some implementations of the wearable device, at least a portion of the data corresponding to the individual is collected by the MEMS.

In some implementations of the wearable device, the MEMS comprises one or more microphones.

In some implementations of the wearable device, the MEMS comprises one or more accelerometers.

The systems and methods described herein may be used to generate a data collection system that is more scalable than manual methods. In addition, these systems and methods may be more accurate and reliable than solely user-provided labels, as users may forget to enter their label, cannot enter it a given time, or cannot remember when an event happened. Additional data points may be collected by using the methods and systems described herein that might not be collected using other data collection and labelling methods.

Various implementations of the present technology provide a non-transitory computer-readable medium storing program instructions for executing one or more methods described herein, the program instructions being executable by a processor of a computer-based system.

Various implementations of the present technology provide a computer-based system, such as, for example, but without being limitative, an electronic device comprising at least one processor and a memory storing program instructions for executing one or more methods described herein, the program instructions being executable by the at least one processor of the electronic device.

In the context of the present specification, unless expressly provided otherwise, a computer system or computing environment may refer, but is not limited to, an “electronic device,” a “computing device,” an “operation system,” a “system,” a “computer-based system,” a “computer system,” a “network system,” a “network device,” a “controller unit,” a “monitoring device,” a “control device,” a “server,” and/or any combination thereof appropriate to the relevant task at hand.

In the context of the present specification, unless expressly provided otherwise, any of the methods and/or systems described herein may be implemented in a cloud-based environment, such as, but not limited to, a Microsoft Azure environment, an Amazon EC2 environment, and/or a Google Cloud environment.

In the context of the present specification, unless expressly provided otherwise, the expression “computer-readable medium” and “memory” are intended to include media of any nature and kind whatsoever, non-limiting examples of which include RAM, ROM, disks (e.g., CD-ROMs, DVDs, floppy disks, hard disk drives, etc.), USB keys, flash memory cards, solid state-drives, and tape drives. Still in the context of the present specification, “a” computer-readable medium and “the” computer-readable medium should not be construed as being the same computer-readable medium. To the contrary, and whenever appropriate, “a” computer-readable medium and “the” computer-readable medium may also be construed as a first computer-readable medium and a second computer-readable medium.

In the context of the present specification, unless expressly provided otherwise, the words “first,” “second,” “third,” etc. have been used as adjectives only for the purpose of allowing for distinction between the nouns that they modify from one another, and not for the purpose of describing any particular relationship between those nouns.

Additional and/or alternative features, aspects and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a block diagram of an example computing environment in accordance with various embodiments of the present technology;

FIG. 2 is a block diagram of a system for collecting and labelling data in accordance with various embodiments of the present technology;

FIG. 3 illustrates a diagram of a method for training a machine learning algorithm (MLA) using labelled data points in accordance with various embodiments of the present technology;

FIG. 4 illustrates a diagram of a method for generating a prediction using a trained MLA in accordance with various embodiments of the present technology;

FIG. 5 illustrates a flow diagram of a method for generating labelled data points in accordance with various embodiments of the present technology; and

FIG. 6 illustrates an interface for entering a timestamp in accordance with various embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that one or more modules may include for example, but without being limitative, computer program logic, computer program instructions, software, stack, firmware, hardware circuitry, or a combination thereof.

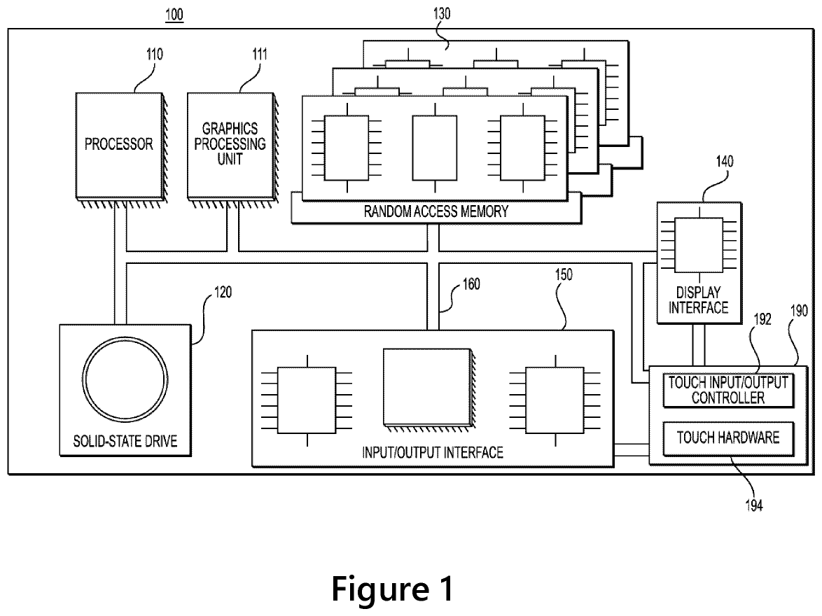

FIG. 1 illustrates a computing environment 100, which may be used to implement and/or execute any of the methods described herein. In some embodiments, the computing environment 100 may be implemented by any of a conventional personal computer, a computer dedicated to managing network resources, a network device and/or an electronic device (such as, but not limited to, a mobile device, a tablet device, a server, a controller unit, a control device, a wearable device such as a watch, etc.), and/or any combination thereof appropriate to the relevant task at hand. In some embodiments, the computing environment 100 comprises various hardware components including one or more single or multi-core processors collectively represented by processor 110, a solid-state drive 120, a random access memory 130, and an input/output interface 150. The computing environment 100 may be a computer specifically designed to operate a machine learning algorithm (MLA). The computing environment 100 may be a generic computer system.

In some embodiments, the computing environment 100 may also be a subsystem of one of the above-listed systems. In some other embodiments, the computing environment 100 may be an “off-the-shelf” generic computer system. In some embodiments, the computing environment 100 may also be distributed amongst multiple systems, such as within a cloud computing environment and/or any other virtual environment. The computing environment 100 may also be specifically dedicated to the implementation of the present technology. As a person in the art of the present technology may appreciate, multiple variations as to how the computing environment 100 is implemented may be envisioned without departing from the scope of the present technology.

Those skilled in the art will appreciate that processor 110 is generally representative of a processing capability. In some embodiments, in place of or in addition to one or more conventional Central Processing Units (CPUs), one or more specialized processing cores may be provided. For example, one or more Graphic Processing Units (GPUs), Tensor Processing Units (TPUs), and/or other so-called accelerated processors (or processing accelerators) may be provided in addition to or in place of one or more CPUs.

System memory will typically include random access memory 130, but is more generally intended to encompass any type of non-transitory system memory such as static random access memory (SRAM), dynamic random access memory (DRAM), synchronous DRAM (SDRAM), read-only memory (ROM), or a combination thereof. Solid-state drive 120 is shown as an example of a mass storage device, but more generally such mass storage may comprise any type of non-transitory storage device configured to store data, programs, and other information, and to make the data, programs, and other information accessible via a system bus 160. For example, mass storage may comprise one or more of a solid state drive, hard disk drive, a magnetic disk drive, and/or an optical disk drive.

Communication between the various components of the computing environment 100 may be enabled by a system bus 160 comprising one or more internal and/or external buses (e.g., a PCI bus, universal serial bus, IEEE 1394 “Firewire” bus, SCSI bus, Serial-ATA bus, ARINC bus, etc.), to which the various hardware components are electronically coupled.

The input/output interface 150 may allow enabling networking capabilities such as wired or wireless access. As an example, the input/output interface 150 may comprise a networking interface such as, but not limited to, a network port, a network socket, a network interface controller and the like. Multiple examples of how the networking interface may be implemented will become apparent to the person skilled in the art of the present technology. For example the networking interface may implement specific physical layer and data link layer standards such as Ethernet, Fibre Channel, Wi-Fi, Token Ring or Serial communication protocols. The specific physical layer and the data link layer may provide a base for a full network protocol stack, allowing communication among small groups of computers on the same local area network (LAN) and large-scale network communications through routable protocols, such as Internet Protocol (IP).

The input/output interface 150 may be coupled to a touchscreen 190 and/or to the one or more internal and/or external buses 160. The touchscreen 190 may be part of the display. In some embodiments, the touchscreen 190 is the display. The touchscreen 190 may equally be referred to as a screen 190. In the embodiments illustrated in FIG. 1, the touchscreen 190 comprises touch hardware 194 (e.g., pressure-sensitive cells embedded in a layer of a display allowing detection of a physical interaction between a user and the display) and a touch input/output controller 192 allowing communication with the display interface 140 and/or the one or more internal and/or external buses 160. In some embodiments, the input/output interface 150 may be connected to a keyboard (not shown), a mouse (not shown) or a trackpad (not shown) allowing the user to interact with the computing environment 100 in addition to or instead of the touchscreen 190.

According to some implementations of the present technology, the solid-state drive 120 stores program instructions suitable for being loaded into the random access memory 130 and executed by the processor 110 for executing acts of one or more methods described herein. For example, at least some of the program instructions may be part of a library or an application.

### System for Collecting and Labelling Data

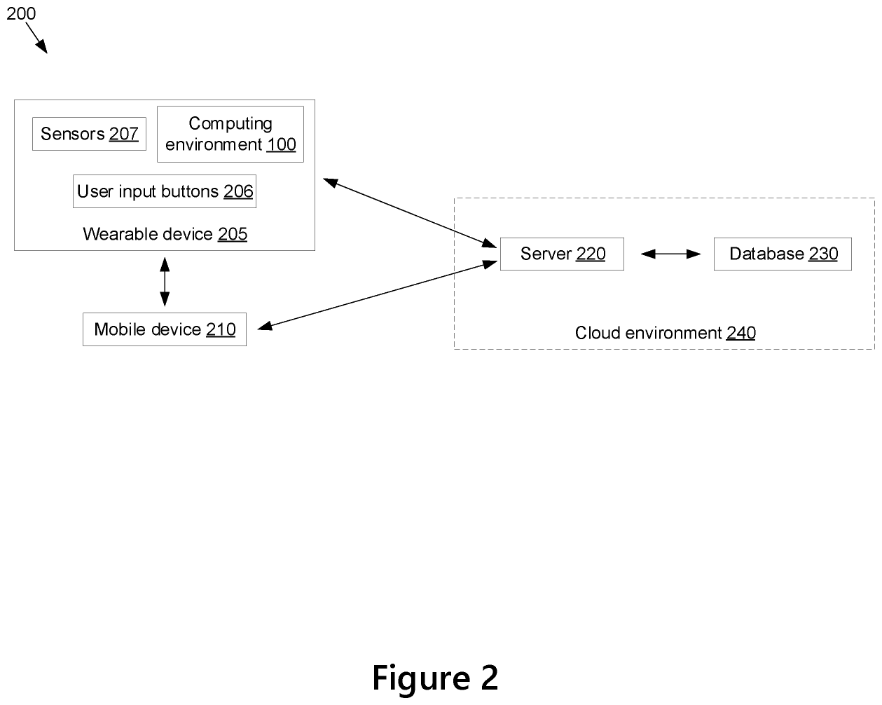

FIG. 2 is a block diagram of a system 200 for collecting and labelling data in accordance with various embodiments of the present technology. It should be understood that the system 200 is exemplary, and that various other systems may be used and/or changes may be made to the system 200. The system 200 includes a wearable device 205 worn by an individual, a mobile device 210 which may be associated with the individual, a server 220, and a database 230. The server 220 and the database 230 may be part of a cloud environment 240. The wearable device 205 may be one of the devices described in Application No. PCT/CA2019/050473 (“Systems and Methods for the Determination of Arousal States, Calibrated Communication Signals and Monitoring Arousal States”).

Various data relating to the individual may be collected. The data may be collected by various sensors, such as sensors 207 contained in the wearable device 205. The data may be processed and/or combined, such as by using sensor fusion to combine different types of data and/or data from multiple sources. The wearable device 205 may be worn by the individual. The wearable device 205 may be a watch, a patch, an item of clothing, or have any other format.

Data about the individual may be collected by any other sensors and/or devices associated with the individual, such as the mobile device 210. The wearable device 205 and mobile device 210 may be in communication, such as via a wireless communication protocol. An application executing on the mobile device 210 may communicate with the wearable device 205. The mobile device 210 may be a smartphone, tablet, and/or any other device or computing environment 100. Any type of data may be collected by the wearable device 205, mobile device 210, and/or other devices. The types of data to be collected may be pre-configured and/or selected based on an application for the data. The wearable device 205 may be configured to collect the requested types of data. The wearable device 205 may be modular, and sensors corresponding to the requested types of data may be placed in the wearable device 205 and/or placed in communication with the wearable device 205.

The sensors 207 may include any type of sensors, such as micro electro-mechanical system (MEMS) sensors, motion sensors, heart rate sensors, inter-beat (RR) interval sensors, electrodermal activity (EDA) sensors, skin temperature sensors, environmental sensors, wearable battery sensors, any type of heart data sensors, microphones, and/or any other type of sensors. The MEMS sensor may include an accelerometer, gyroscope, microphone, and/or other types of sensors.

The wearable device 205 may include a computing environment 100, such as a processor and memory. The wearable device 205 may contain an FPGA. The FPGA may be configured for a particular use and/or environment of the wearable device 205. As described in further detail below, the wearable device 205 may be configured to collect data, label collected data, determine that an event has occurred, encrypt collected data and labels, and/or transmit the encrypted data. The encrypted data may be transmitted to the server 220.

The wearable device 205 may include user input buttons 206 and/or any other interface for entering input, such as a touch screen display, pressure or motion sensors, dials, switches, etc. Motions, gestures, and/or positions of the individual and/or any other user may be determined and used as input. For example, the wearable device 205 may determine motions of the user wearing the device using accelerometer data. Those motions may be mapped to various types of input. Icons and/or interfaces may be projected onto a surface, such as by the wearable device 205. User interactions with the icons and/or interface may be captured and used as input. Labels may be determined based on the user input.

The user input buttons 206 or other input methods may be used to indicate that an event has occurred, receive a label for an event, and/or other uses. Input may be received via the mobile device 210. The individual may press one of the user input buttons 206 on the wearable device 205 to indicate that an event has occurred. A timestamp corresponding to the event may be recorded by the wearable device 205. The individual may enter a label for the event using an interface displayed on the mobile device 210. Voice input or other audio input may be received by one or more microphones in the wearable device 205 and/or mobile device 210. The mobile device 210 is optional. The wearable device 205 may perform all actions performed by the mobile device 210, such as via a touch screen in the wearable device 205.

Data may be collected through various different methods, such as: collected by the wearable device 205 worn by the individual, collected by a clinician, submitted by the individual, submitted by an observer, submitted by any other user working with the individual, and/or collected through any other means.

The data may be physiological data and/or any other type of data regarding the individual. The physiological data may include a heart rate, a breathing rate, a measure of blood flow, a sweat analysis, a measure of movement, acoustic signals, an electrical brain signal, a temperature, a breath analysis, a biomarker of stress, blood pressure, a blood glucose measurement, a blood oxygen level, levels of stress hormones such as cortisol, pheromonal signaling such as for stress and/or fear, hydration levels, electrolyte levels, and/or any other physiological data. The physiological data may be collected through any means for collecting physiological data, including measurements from saliva, a blood assay, sweat analysis, and/or input in an application.

Data from multiple sources may be collected and aggregated. The data may be aggregated based on the timestamps, trends, distributions, and/or derived temporal parametric values. The derived temporal parametric values may include standard deviation of the average normal-to-normal intervals (SDANN), extended Poincare Sx and Sy over hours to days (for heart rate variability), and/or similar analogies for treating Electrodermal and other continuous physiological datasets. The data may be aggregated based on phase angle for externally generated periodic signals from which physiological parameters can be extracted from carrier waves, such as Extrinsic A/C Electrodermal Measurements.

Instead of or in addition to measured values, synthetic data may be collected or generated. The synthetic data may be collected or generated for a real individual or a generated individual. The collected and/or generated data may be medical data and/or any other type of data. All methods and systems described herein may be applied to actual data, synthetic data, or a combination of measured and synthetic data.

The data may be timestamped to indicate when the data was collected. A clock in the wearable device 205 or mobile device 210 may be used to generate the timestamp. The timestamp may be a specific time and/or a period of time. For example the timestamp may include a start time and an end time.

An interface may be output to a user, such as the individual and/or the clinician to label the collected data. The interface may be output on the wearable device 205, mobile device 210, and/or any other device. Data points may be recorded and/or labelled, such as using the interface. Each data point may include a timestamp, data corresponding to the timestamp, and/or one or more labels. The timestamp may indicate a specific time and/or a period of time. The data point may be labelled using any one or more of the following three methods which are discussed below: immediate labelling, near real-time labelling, and/or after the fact labelling.

The labels may include numerical data. The numerical data may be collected by displaying a range of numbers to the individual, and the individual may select a number. For example, the interface may display “How do you feel? Please rate from 1 to 10” and the individual may then input a numeral on the interface. The label may include nominal data, which may be a category selected from a finite list of unordered categories. For example, the individual may be asked to select from the categories “nose,” “throat,” or “mouth.” The individual may be able to select more than one category. The label may include ordinal data, which may be a category selected from an ordered list of categories. For example, the available labels may be “vaccinated once,” “vaccinated twice,” or “vaccinated three times.”

Any of the interfaces used for collecting labels may include a request for consent. The request for consent may include a request to consent to the collection of data, labelling of data, use of data, and/or any other type of consent. The request may include a description of how the collected data will be used. If the user does not consent to the collection and/or labelling of data, any collected data may be deleted and/or additional data might not be collected.

The collected data and/or labels may be transmitted by the wearable device 205, mobile device 210, and/or any other suitable device to a server 220 in a cloud environment 240. The server 220 may store the collected data on a database 230. The database 230 may also be in the cloud environment 240. The data may be processed by the server 220.

The wearable device 205 and/or mobile device 210 may process the data in an edge computing configuration. Actions performed by the wearable device 205 and/or mobile device 210 may include determining when an event has occurred, recording a timestamp corresponding to an event, applying a label to the event, encrypting collected data corresponding to the event and the label, and/or any other data processing using the collected data and/or labels. Security of the system 200 may be improved by processing the data in an edge configuration. Additionally, less resources may be consumed by processing the data in the edge configuration. After the labelling is completed by edge computing, such as by the wearable device 205 mobile device 210 and/or an edge computing device, the labelled data may be encrypted and transmitted to the server 220 in the cloud environment 240.

Some or all of the steps performed by MLAs as described below may be performed by the wearable device 205, mobile device 210, and/or other edge computing devices. Reservoir computing may be used to place the MLA in a format that can be executed efficiently by the wearable device 205, mobile device 210, and/or other edge computing device.

### Training and Using an MLA

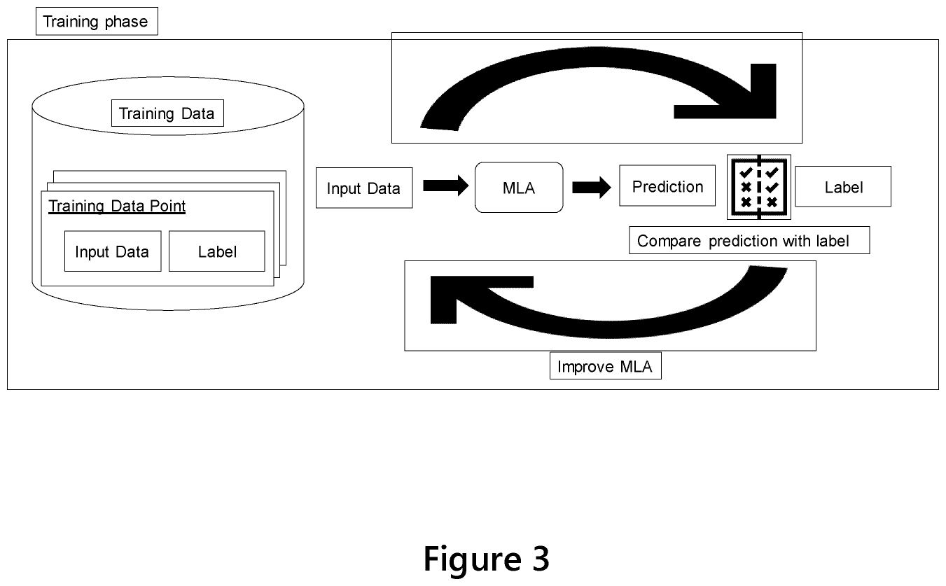

The data collected and/or labelled by the system 200 may be used to train an MLA. FIG. 3 illustrates a diagram of a method for training the MLA using labelled data points, such as data points labelled using the system 200, in accordance with various embodiments of the present technology. During the training phase of the MLA, training data may be collected. The training data may include any number of training data points. Each training data point may include input data and a corresponding label.

The input data may include data collected by the system 200, such as data collected by sensors. The input data may be collected data that corresponds to an event. The input data may be data collected within a period of time surrounding the timestamp of the event. The input data may include the results of a questionnaire and/or other data input by an individual.

The label may be based on input entered by the individual, such as input entered using the wearable device 205 and/or mobile device 210. Various methods for labelling the input data are described below in further detail.

The MLA may comprise any type and/or combination of machine learning models. The MLA may include neural networks, decision trees, and/or any other type of model. The neural networks may be artificial, convolutional, recurrent, and/or any other type of neural network. In order to train the MLA, the input data of a training data point may be input to the MLA. The MLA may then output a prediction based on the input data. The prediction may be compared to the label of the data point. A loss function may be used to determine a difference between the label and the prediction. The MLA may then be improved based on the difference between the label and the prediction. This process may be repeated until the MLA is considered to be trained. Any suitable method may be used to confirm that the MLA has been sufficiently trained, such as when the average prediction error of the MLA is below a threshold and/or when the MLA has reached a homeostatic equilibrium or condition of optimal functioning.

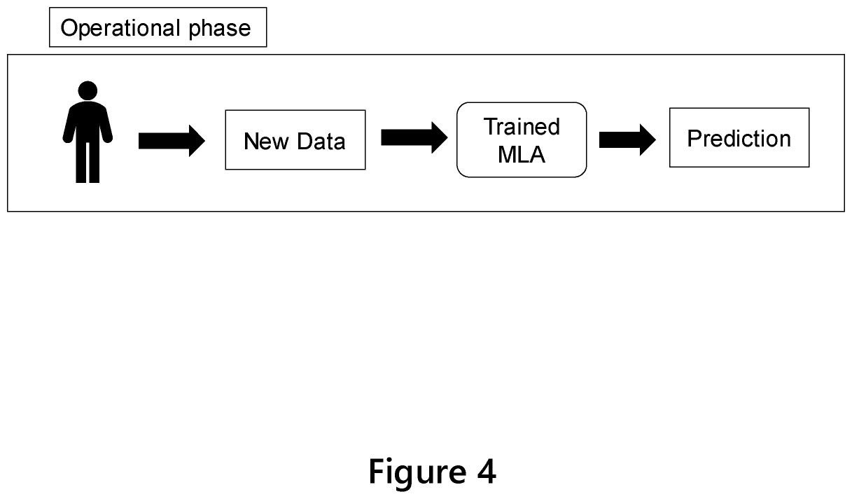

FIG. 4 illustrates a diagram of a method for generating a prediction using a trained MLA in accordance with various embodiments of the present technology. After the MLA has been trained, such as using the method illustrated in FIG. 3, the MLA may be used during an operational phase to generate a prediction. New data may be input to the trained MLA. The new data may be in the same format as the input data used to train the MLA. The trained MLA may then output a prediction based on the input data.

The quality of the predictions made by the trained MLA rely on the quality of the training data used to train the MLA. Accurately labelling the training data may improve the quality of the predictions output by the MLA. In order to generate training data of sufficient quality, various methods for labelling collected data are described below.

### Immediate Labelling

In a method of immediate labelling, when an event occurs, such as when an individual engages in an activity or experiences a symptom, the individual immediately inputs that the event is occurring and/or provides a label describing the event. The label may be the symptom, the activity, and/or any other label. For example, if the individual is having trouble breathing, the individual may input that they are experiencing breathing difficulties. A data point may be recorded that includes a timestamp indicating when the individual entered the input. The data point may include a label indicating that the individual was experiencing breathing difficulties.

As described above, the individual may enter the label using a wearable device with input buttons, through a tablet (such as an iPad), a mobile device such as a smartphone, and/or using any other device. The labels may be preset, such as preset coded labels for each button of the wearable device or preset selectable labels on an application. The labels may be manually entered by the individual, such as by entering text in an application. The labels may be entered via gesture input, sign language input, and/or any other type of input. The labels may be entered by the individual in a linked and/or synchronized application on an individual's device, such as a voice activated digital personal assistant.

### Near Real-Time Labelling

In a method of near real-time labelling, rather than a voluntary and immediate labelling by the user, the individual may be prompted to enter a label. An event may be detected. The event may be a physiological event, such as an increase in heart rate. A data point may be created and/or stored that includes a timestamp of the event. After detecting the event, the individual may be asked whether they are experiencing any symptoms. When the user responds to the question, the user's response may be stored as a label corresponding to the data point.

The event may be detected using an anomaly detection system. The anomaly detection system may include one or more machine learning algorithms (MLAs). The MLAs may be trained with labelled data, where the labels indicate whether or not the labelled data corresponds to an anomaly. Other types of algorithms may be used for anomaly detection, such as a parametric formula. One or more baseline measurements may be determined. Then, the deviation from the baseline measurements may be determined, such as using a Gaussian method. If a significant deviation is detected, the user may be prompted to enter a label for the time corresponding to the deviation.

For example, an increase in skin temperature may be detected and the user may be asked whether they are experiencing any symptoms. The user may then respond that they are feeling disoriented, and a data point may be generated that includes this label and the timestamp corresponding to the increase in skin temperature.

The individual can also record that an event is occurring at the time of the event but without providing a label for the event. A data point may be generated and/or stored when the individual records that the event is occurring. The data point may include a timestamp corresponding to the event. The individual will then be prompted to go back at a later time and input a label for the data point. That label will then be associated with the previously recorded timestamp. For example, the individual may press a button on a wearable to indicate that an event is occurring. A timestamp corresponding to the user input may be stored as a data point. The user may later enter a label for the event, and that label may be assigned to the data point that was previously generated.

### Example of Near Real-Time Labelling

The following is an example of near real-time labelling where a diabetic individual enters input signalling that an important physiological event has occurred but the individual is unable to articulate the event or provide additional detail about the event until after the event has occurred.

At 9 am the individual takes a medication with food and enters input logging the medication, dosage, and that food was eaten. At noon the individual eats lunch but did not have enough time to complete their lunch. The individual enters input describing that a partial lunch was consumed.

At 2:45 pm the individual notices that their peripheral vision is darkening. The user presses a red button on their wearable device three times, which is a signal that an event of significant urgency is occurring. A data point is stored indicating a time of the input and a description of the input.

At 2:46 pm the individual passes out while trying to reach for an emergency medication. At 2:47 pm a fall detection system in the wearable device detects that the individual has fallen. The fall detection system causes a notification to be sent, such as to a nearby person or caregiver. At 2:49 pm the caregiver helps the individual through the hypoglycemia crisis that they are experiencing until 9 pm.

After the crisis has been controlled, a label may be added to the data point recorded at 2:45 pm indicating that this data point is the start of a hypoglycemia crisis. By reviewing all of the recorded data, the individual, caregiver, and/or physician may conclude that the hypoglycemia crisis was caused by a reduction in caloric intake (the partially eaten lunch) rather than inappropriate treatment.

### After the Fact Labelling

In a method of after the fact labelling, data points may be generated by the individual and/or a clinician after the underlying data has been collected. The labels and/or timestamps for these data points may be determined by asking the individual questions, by the individual filling out a questionnaire, etc. These data points, in certain embodiments, may be less accurate than the immediate or near real-time labelling because they are collected after events have occurred. The timestamps may be less accurate and/or less precise. Similarly, the labels may be less accurate because they rely on the individual's memory. These data points might not be linked to a timestamp corresponding to an event, such as if an individual recalls that a symptom occurred but cannot recall when the symptom occurred.

The individual and/or clinician may edit previously generated data points. The individual and/or clinician may adjust the timestamp and/or labels of a data point. For example, after a diagnosis is received the diagnosis may be added as a label to previously generated data points to indicate that the data points correspond to the diagnosis. A single data point may be assigned multiple labels. For example, a single data point may have been assigned a label corresponding to a symptom as an immediate label, and then later a diagnosis may be added as an after the fact label.

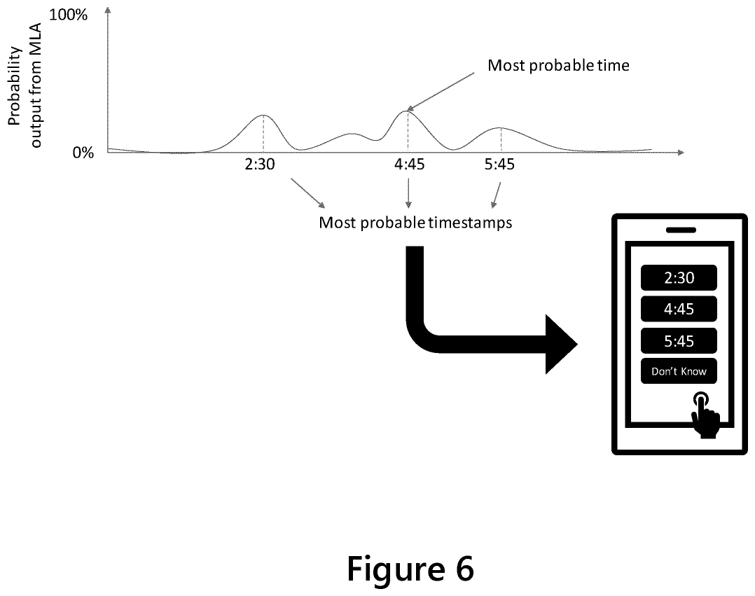

The individual may provide a label but be uncertain about the time corresponding to the label. For example, the individual may enter input that at one point during the previous day the individual went for a walk, but the individual might not know at what time they went for a walk. The collected data may be analyzed to identify one or more time periods during which the label is likely to have occurred. FIG. 6 illustrates an interface for entering a timestamp in accordance with various embodiments of the present technology.

In FIG. 6, an MLA is used to identify the most likely timestamps corresponding to a label input by the user. The collected data relating to the individual or human phenotype may be input to the MLA, and the MLA may output, for each time period, a likelihood that the label corresponds to that time period. The timestamps that are predicted to be most likely to correspond to the label may then be output to the individual on a user interface. The individual may select one of those timestamps and that timestamp may be applied to the data. In this manner, a label can be created for data even when the individual is unsure of when the event corresponding to the label occurred.

### Automated Labelling

In a method of automated labelling, after an initial set of data points have been labelled, such as using the methods described above, semi-supervised learning may be used to label additional collected data that is unlabelled. Machine learning algorithms (MLAs) may be trained, using the labelled data points, to label the additional collected data. For example, the initial set of labelled data points may be used to define a set of clusters, and the MLAs may be trained to label the additional collected data as corresponding to a cluster of the set of clusters.

The three different types of labelling described above may provide data points that can be used for semi-supervised learning. Threshold amounts of data points may be determined for training the MLA, and/or a threshold accuracy of the MLA may be selected where training data continues to be collected until the threshold accuracy is met. The amount of data points labelled with immediate labelling used for training the MLA may be reduced by supplementing the dataset with data points collected using near real-time labelling and after the fact labelling.

The MLAs may determine timestamps to label and/or labels for the timestamps. The timestamps and/or labels may be stored as data points. The individual, clinician and/or a third party such as a carer may be asked to confirm a label and/or select from a set of labels. For example, the MLA may output a set of labels that are predicted to apply to a timestamp. The user may be asked to confirm whether any labels of the set of labels apply to the timestamp. For example, if the MLA predicts that a user experienced a seizure at 3:45 pm, the user may be asked “Did you have a seizure at 3:45 pm?” If the user indicates that they did have a seizure at that time, a data point may be stored with a timestamp of 3:45 pm and a label indicating that a seizure occurred.

The MLA may output a likelihood that a label applies to input data. If the likelihood is below a threshold, the individual or another user may be asked to confirm the label. For example, the MLA may be trained to predict whether an individual was infected with a disease. The MLA may output that there is a high predicted likelihood that the individual was infected with the disease, but the likelihood may be lower than the threshold. An interface may be output to the individual to confirm that the individual was infected with the disease. For example, the interface may say “It appears we are unable to predict with high fidelity whether you had COVID-19 four days ago. Please help us confirm if you can.” The user may be able to select one of the following options: 1) Yes, I'm sure I was infected then, 2) No, I'm sure I was not infected then, or 3) I'm unsure whether I was infected then. The label user input may then be used to apply a corresponding label to the collected data.

The MLAs may be used to refine data points that were generated based on user input. For example, a user may enter an approximate time that an event occurred, and the MLA may determine a predicted time that the event occurred based on recorded physiological data and/or other recorded data. The user may be asked to confirm that the event occurred at the predicted time. The timestamp of the data point may be updated based on the time determined by the MLA.

### Examples of Confirming/Editing Automated Labelling

As described above, an individual, clinician, caregiver, and/or other user may confirm and/or modify the labels generated by an MLA. The following is an example of editing automatically generated labels. At 3 pm an individual having diabetic neuropathy and autonomic dysfunction has a physiological event, such as dizziness, increased heart rate, spike in electrodermal activity (EDA), and low blood pressure. The physiological event occurs because the individual stood up quickly after lying down on a sofa.

The MLA generates a label for this physiological event that indicates that a possible hypoglycemia event occurred with a timestamp of 3 pm. The MLA labels this as a possible hypoglycemia event due to a similarity in features between previously recorded hypoglycemia events and the physiological event that occurred at 3 pm. At the end of the day the individual reviews a dashboard of events that occurred that day. The individual recognizes that the label “possible hypoglycemia event” is inaccurate and instead labels the data point with the label “pre-syncope, postural change tachycardia, anxiety trigger”.

This review and/or editing performed by the individual may increase specificity of the labelling, reduce false positives, and/or reduce false negatives.

In another example, an individual has Thoracic Outlet Syndrome (TOS). The individual has an extra superior rib that partially occludes the subclavian artery. When the individual sits at a desk this occlusion worsens and manifests as heart rate variability instability and paresthesia down the affected arm. The individual wears a wearable on the left arm which is the arm affected by TOS. The physiological data measured by the wearable when the individual sits at a desk is labelled by the MLA as symptoms of heart disease, rather than correctly labelling the data point as symptoms of TOS. The individual's doctor then reviews the label generated by the MLA, compares it with ECG measurements taken concurrently, and decides that the heart disease risk is in fact a regional vascular issue. The doctor then edits the label.

### Output

A set of labelled data points may be output, where some of the labels were applied by the individual and/or clinician and some labels were automatically applied using semi-supervised learning. The data points may be used for various purposes, such as research, determining digital biomarkers, predictions, and/or other purposes. Digital biomarkers may be derived using one or more algorithms that have been trained with labelled datasets. The digital biomarkers may replace and/or be used in addition to conventional biomarkers. For example, a digital biomarker may be used in combination with a conventional biomarker of a blood sample parameter value above or below a threshold. The data points may be collected as part of a clinical study.

### Method for Generating Labelled Data Points

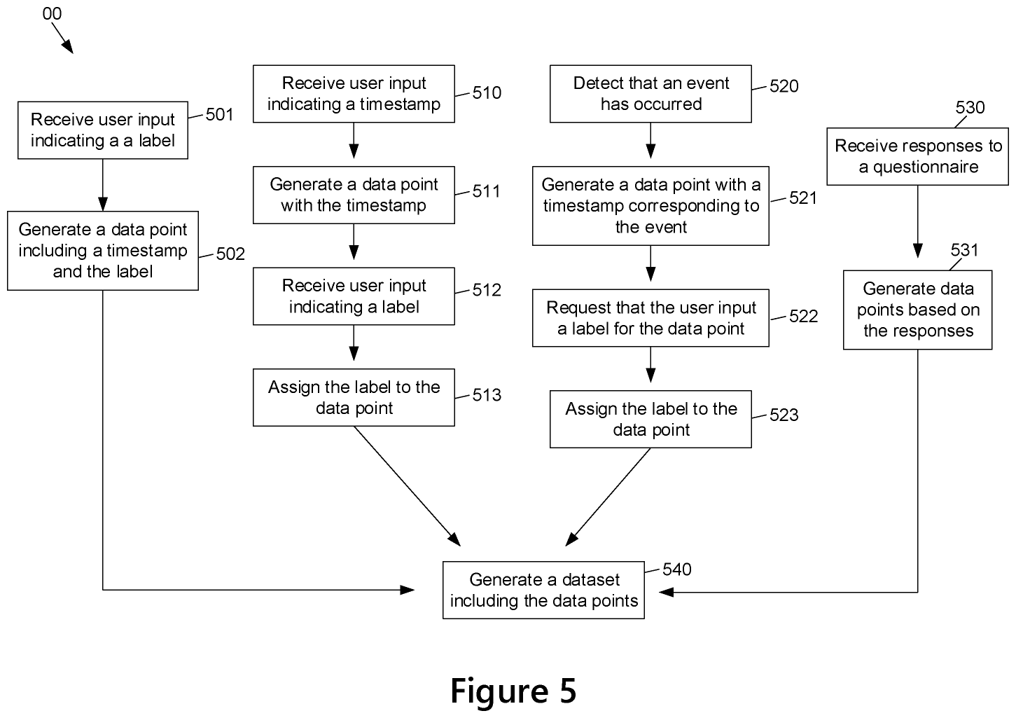

FIG. 5 illustrates a flow diagram of a method 500 for generating labelled data points in accordance with various embodiments of the present technology. In one or more aspects, the method 500 or one or more steps thereof may be performed by a computing system, such as the computing environment 100, server 220, wearable device 205, and/or mobile device 210. The method 500 or one or more steps thereof may be embodied in computer-executable instructions that are stored in a computer-readable medium, such as a non-transitory mass storage device, loaded into memory and executed by a CPU. Some steps or portions of steps in the flow diagram may be omitted or changed in order.

Steps 501-502 correspond to immediate labelling. At step 501 user input may be received indicating a label. At step 502 a data point may be generated that includes the label and a timestamp indicating when the input was received at step 501.

Steps 510-513 and 520-523 correspond to near real-time labelling. At step 510 user input may be received indicating that an event is occurring. At step 511 a data point may be generated with a timestamp indicating when the input was received at step 510. User input indicating a label may later be received at step 512. The label may be assigned to the data point at step 513.

An event may be detected at step 520, such as based on a change in measured physiological data. The event may be detected by an MLA and/or a parametric equation. A data point with a timestamp of the event may be generated at step 521. At step 522 a request may be output to the user to provide a label for the data point. User input may be received indicating a label, and at step 523 the label may be applied to the data point.

Steps 530 and 531 correspond to after the fact labelling. At step 530 responses to a questionnaire may be received. The questionnaire may be completed by the individual. Other types of input may be received at step 530, such as input from a clinician or a carer. The clinician may input data based on an examination of the individual. At step 531 data points may be generated based on the data received at step 530. Each data point may include a label and/or a timestamp. For example if the questionnaire asks whether the individual has experienced nausea in the past week, and the individual responds indicating that they have experienced nausea in the past week, a data point may be generated that includes a label indicating nausea and a timestamp that indicates a period of time corresponding to the past week.

A dataset may be generated at step 540 that includes the data points generated by each of the different types of labelling. The dataset may include data points generated by one type of labelling and/or data points generated using any combination of the different types of labelling. The dataset may include data points generating at steps 502, 513, 523, and/or 531. Multiple datasets may be generated, such as a dataset for each of the different types of labelling. The multiple datasets may be combined.

The dataset may be used for research, as part of a clinical study, to train an MLA, to make predictions related to the individual, and/or various other uses. The dataset may be used to determine a probability of a condition of the individual, such as predicting whether the individual is suffering from a viral infection. The dataset may be used to evaluate the immune response of the individual, such as after the individual receives a vaccination. The dataset may be used to predict an amount of energy the individual has in reserve, such as for alerting the individual that they should rest before fatigue sets in. The dataset may be used for creating a digital twin of the individual, which may include a stored set of parameters that describe the individual. The dataset may be used for monitoring a condition of the individual, such as for predicting whether an individual is in remission. The dataset may be used for determining prodromes, symptoms, or surrogate biomarkers of the individual.

The dataset may indicate how each of the data points was generated. Each data point in the dataset may include an indicator of whether the data point was generated using immediate labelling, near real-time labelling, or after the fact labelling. The data points may include a timestamp indicating when the label was applied to the data point. When using the dataset, such as to train an MLA, the data points may be weighted differently depending on whether they were labelled immediately, in near real-time, or after the fact. The weight may be determined based on a difference between the time that the data point was labelled and the timestamp of the data point (i.e. when the event corresponding to the data point occurred).

The dataset may be used for identifying biomarkers of a condition. The biomarkers may be in any format, such as digital biomarkers based on data collected by the wearable device 205. The dataset may be used to identify one or more biomarkers for a disease, such as COVID-19. The determined biomarkers for COVID-19 may then be used to determine whether an individual currently has a COVID-19 infection or to detect early signs of an infection from an asymptomatic individual.

While some of the above-described implementations may have been described and shown with reference to particular acts performed in a particular order, it will be understood that these acts may be combined, sub-divided, or re-ordered without departing from the teachings of the present technology. At least some of the acts may be executed in parallel or in series. Accordingly, the order and grouping of the act is not a limitation of the present technology.

It should be expressly understood that not all technical effects mentioned herein need be enjoyed in each and every embodiment of the present technology.

As used herein, the wording “and/or” is intended to represent an inclusive-or; for example, “X and/or Y” is intended to mean X or Y or both. As a further example, “X, Y, and/or Z” is intended to mean X or Y or Z or any combination thereof.

The foregoing description is intended to be exemplary rather than limiting. Modifications and improvements to the above-described implementations of the present technology may be apparent to those skilled in the art.

1. A method for generating a dataset of labelled data points, the method comprising:
recording, by a device, data corresponding to an individual;
receiving, by the device at a first time, first input corresponding to a first label;
storing a first data point, wherein the first data point comprises:
a first timestamp corresponding to the first time,
the first label, and
a first portion of the data corresponding to the first time;
receiving, by the device at a second time, second input;
storing a second data point, wherein the second data point comprises:
a second timestamp corresponding to the second time, and
a second portion of the data corresponding to the second time;
receiving user input indicating a second label for the second time;
assigning the second label to the second data point;
determining, based on the data, that an event has occurred at a third time;
outputting a first user interface indicating that an event has occurred;
receiving, via the first user interface, a third label corresponding to the event;
storing a third data point, wherein the third data point comprises:
a third timestamp corresponding to the third time,
the third label, and
a third portion of the data corresponding to the event; and
storing the dataset of labelled data points comprising the first data point, the second data point, and the third data point.

2. The method of claim 1, further comprising training a machine learning algorithm based on the dataset.

3. The method of any one of claims 1-2, further comprising:
outputting a second user interface requesting that the individual consent to the data being collected; and
receiving, via the second user interface, an indication that the individual has consented to the data being collected.

4. The method of any one of claims 1-3, wherein recording the data corresponding to the individual comprises recording at least a portion of the data by a micro electro-mechanical system (MEMS) in the device.

5. The method of claim 4, wherein the MEMS comprises one or more microphones.

6. The method of claim 5, wherein the MEMS comprises one or more accelerometers.

7. The method of any one of claims 1-6, wherein determining that the event has occurred comprises determining, by the device, that the event has occurred.

8. The method of any one of claims 1-7, further comprising:
encrypting, by the device, the dataset of labelled data points; and
transmitting the encrypted dataset of labelled data points.

9. The method of any one of claims 1-7, further comprising recording, by a second device, second data corresponding to the individual, wherein the first data point comprises a first portion of the second data corresponding to the first time, wherein the second data point comprises a second portion of the second data corresponding to the second time, and wherein the third data point comprises a third portion of the second data corresponding to the third time.

10. The method of any one of claims 1-9, wherein the device is a wearable device.

11. A method for generating a dataset of labelled data points, the method being executable by a processor of a computer system, the method comprising:
receiving, at a first time, first input corresponding to a first label;
storing a first data point, wherein the first data point comprises a first timestamp indicating the first time and the first label;
receiving, at a second time, second input indicating that an event is occurring;
storing a second data point comprising a second timestamp indicating the second time;
receiving, after receiving the second input, third input indicating a second label corresponding to the event;
assigning the second label to the second data point;
receiving responses to a questionnaire completed by an individual;
generating, based on the responses, a third data point comprising a third label; and
storing a dataset comprising the first data point, the second data point, and the third data point.

12. The method of claim 11, further comprising performing semi-supervised learning on the dataset to generate a machine learning algorithm (MLA) for labelling data points.

13. The method of claim 12, further comprising:
receiving physiological data corresponding to the individual;
determining, based on the physiological data, a third timestamp corresponding to an event;
generating, by the MLA, one or more predicted labels for the third timestamp;
generating a fourth data point comprising the third timestamp and the one or more predicted labels; and
storing the fourth data point in the dataset.

14. The method of any one of claims 11-13, further comprising outputting a user interface for labelling data, and wherein the first input, second input, and third input are received via the user interface.

15. The method of any one of claims 11-14, wherein receiving the first input comprises receiving, via a wearable device, the first input.

16. The method of any one of claims 11-14, wherein receiving the second input comprises receiving, via a wearable device, the second input.

17. The method of claim 16, wherein receiving the third input comprises receiving, via a user interface for data labelling, the third input.

18. The method of claim 17, wherein the user interface for data labelling is displayed by a personal computer, tablet, or smartphone.

19. The method of any one of claims 11-14, wherein receiving the first input, second input, or third input comprises receiving hand gesture input or sign language input.

20. A method for generating a dataset of labelled data points, the method comprising:
recording, by a device, data corresponding to an individual;
receiving, by the device at a first time, first input corresponding to a first label;
storing a first data point, wherein the first data point comprises:
a first timestamp corresponding to the first time,
the first label, and
a first portion of the data corresponding to the first time;
determining, based on the data, that an event has occurred at a second time;
outputting a first user interface indicating that an event has occurred;
receiving, via the first user interface, a second label corresponding to the event;
storing a second data point, wherein the second data point comprises:
a second timestamp corresponding to the second time,
the second label, and
a second portion of the data corresponding to the event; and
storing the dataset of labelled data points comprising the first data point and the second data point.

21. The method of claim 20, further comprising training a machine learning algorithm based on the dataset.

22. The method of any one of claims 20-21, further comprising:
outputting a second user interface requesting that the individual consent to the data being collected; and
receiving, via the second user interface, an indication that the individual has consented to the data being collected.

23. The method of any one of claims 20-22, wherein recording the data corresponding to the individual comprises recording at least a portion of the data by a micro electro-mechanical system (MEMS) in the device.

24. The method of claim 23, wherein the MEMS comprises one or more microphones.

25. The method of any one of claims 23-24, wherein the MEMS comprises one or more accelerometers.

26. The method of any one of claims 20-25, wherein determining that the event has occurred comprises determining, by the device, that the event has occurred.

27. The method of any one of claims 20-26, further comprising:
encrypting, by the device, the dataset of labelled data points; and
transmitting the dataset of labelled data points.

28. The method of any one of claims 20-27, further comprising recording, by a second device, second data corresponding to the individual, wherein the first data point comprises a first portion of the second data corresponding to the first time, and wherein the second data point comprises a second portion of the second data corresponding to the second time.

29. The method of any one of claims 20-28, wherein the device is a wearable device.

30. A system comprising:
at least one processor, and
memory storing a plurality of executable instructions which, when executed by the at least one processor, cause the system to perform the method of any one of claims 1-29.

31. A wearable device comprising at least one processor, and memory storing a plurality of executable instructions which, when executed by the at least one processor, cause the wearable device to:
recording data corresponding to an individual;
receive, at a first time, first input corresponding to a first label;
store a first data point, wherein the first data point comprises:
a first timestamp corresponding to the first time,
the first label, and
a first portion of the data corresponding to the first time;
receive, at a second time, second input;
store a second data point, wherein the second data point comprises:
a second timestamp corresponding to the second time, and
a second portion of the data corresponding to the second time;
receive user input indicating a second label for the second time;
assign the second label to the second data point;
determine, based on the data, that an event has occurred at a third time;
receive a third label corresponding to the event;
store a third data point, wherein the third data point comprises:
a third timestamp corresponding to the third time,
the third label, and
a third portion of the data corresponding to the event; and
store a dataset of labelled data points comprising the first data point, the second data point, and the third data point.

32. The wearable device of claim 31, wherein the instructions, when executed by the at least one processor, cause the wearable device to encrypt the dataset of labelled data points.

33. The wearable device of any one of claims 31-32, wherein the instructions, when executed by the at least one processor, cause the wearable device to transmit the dataset of labelled data points to a server.

34. The wearable device of claim 31, further comprising a micro electro-mechanical system (MEMS).

35. The wearable device of claim 34, wherein at least a portion of the data corresponding to the individual is collected by the MEMS.

36. The wearable device of any one of claims 34-35, wherein the MEMS comprises one or more microphones.

37. The wearable device of any one of claims 34-36, wherein the MEMS comprises one or more accelerometers.
